(19) United States
(12) Patent Application Publication
(10) Pub. No.: US 2002/0061161 A1
(43) Pub. Date: May 23, 2002

(54) Optical switch

(76) Inventors: Andrew Tsiboulia, Nepean (CA); Rajiv Iyer, Nepean (CA)

Correspondence Address: JDS Uniphase Corporation, Intellectual Property Dept., 570 West Hunt Club Road, Nepean, ON, K2G 5W8, CA

(21) Appl. No.: 09/988,275

(22) Filed: Nov. 19, 2001

(30) Foreign Application Priority Data
Nov. 20, 2000 (CA) 2,326,362
Feb. 28, 2001 (CA) 2,338,934

(51) Int. Cl. G02B 6/35

(52) U.S. Cl. 385/18; 385/17; 385/22

(57) ABSTRACT

The present invention provides an optical switch or a large scale fiber-optical cross-connect switch wherein the light from the grouped input fibers is collected by a lens, a lens system, or mirror system, and imaged with a certain magnification to a plane. The plane is either a mirror when the system is operated in reflection, or a plane of symmetry when the system is operated in transmission. Before reaching that plane, the spatially separated beams are intercepted by a (1 or) 2-D micro-mirror input MEMS array, where each mirror can deviate its dedicated input beam to any mirror on the output MEMS array. Each mirror on the output MEMS array compensates for angular tilt and deviates the beam to its dedicated output fiber.

### CROSS-REFERENCE TO RELATED APPLICATIONS

This applications claims priority from Canadian Patent Application No. 2,326,362 filed on Nov. 20, 2000 and Canadian Patent Application No. 2,338,934 filed on Feb. 28, 2001.

### MICROFICHE APPENDIX

Not Applicable

### FIELD OF THE INVENTION

The present invention relates to the field of optical switches.

### BACKGROUND OF THE INVENTION

Optical matrix switches are commonly used in communications systems for transmitting voice, video and data signals. Generally, optical matrix switches include multiple input and/or output ports and have the ability to connect, for purposes of signal transfer, any input port/output port combination, and preferably, for N×M switching applications, to allow for multiple connections at one time. At each port, optical signals are transmitted and/or received via an end of an optical waveguide. The waveguide ends of the input and output ports are optically connected across a switch interface. In this regard, for example, the input and output waveguide ends can be physically located on opposite sides of a switch interface for direct or folded optical pathway communication therebetween, in side-by-side matrices on the same physical side of a switch interface facing a mirror, or they can be interspersed in a single matrix arrangement facing a mirror.

Establishing a connection between a given input port and a given output port, involves configuring an optical pathway across the switch interface between the input ports and the output ports.

One way of configuring the optical path between an input port and an output port involves the use of one or more moveable mirrors interposed between the input and output ports. In this case, the waveguide ends remain stationary and the mirrors are used for switching. The mirrors can allow for two-dimensional targeting to optically connect any of the input port fibers to any of the output port fibers.

An important consideration in switch design is minimizing switch size for a given number of input and output ports that are serviced, i.e., increasing the packing density of ports and beam directing units. It has been recognized that greater packing density can be achieved, particularly in the case of a movable mirror-based beam directing unit, by folding the optical path between the fiber and the movable mirror and/or between the movable mirror and the switch interface. Such a compact optical matrix switch is disclosed in U.S. Pat. No. 6,097,860. In addition, further compactness advantages are achieved therein by positioning control signal sources outside of the fiber array and, preferably, at positions within the folded optical path selected to reduce the required size of the optics path.

Current switch design continuously endeavors to accommodate more fibers in smaller switches.

The general approach in the field of optical cross-connects (OXCs) is to individually collimate each input fiber, and “throw” the beam to its dedicated mirror.

It is an object of this invention to provide an optical switch wherein an input fiber array is imaged to a mirror.

It is another object of the invention to image the input fiber array to a MEMS mirror array.

It is a further object of the invention to provide a compact optical switch or optical cross-connect.

### SUMMARY OF THE INVENTION

In accordance with the invention there is provided, an optical switch comprising an input port for launching a beam of light into the optical switch; a plurality of output ports, each output port for selectively receiving the beam of light; beam directing elements for selectively directing the beam of light from the input port to any one of the plurality of output ports; and an element having optical power for imaging the beam of light.

In accordance with the invention, there is further provided, an optical switch comprising: a plurality of input ports for launching a plurality of light beams into the optical switch; a plurality of output ports, each output port for selectively receiving any one of the plurality of light beams; an optical imaging system for imaging the plurality of light beams from the plurality of input ports to an imaging plane and from the imaging plane to the plurality of output ports; and beam directing elements for selectively directing the plurality of light beams from any one of the plurality of input ports to any one of the plurality of output ports, the beam directing elements being disposed between one of the plurality of input ports and output ports and the imaging plane.

In accordance with another aspect of the invention, there is provided, an optical switch for being operated in one of transmissive and a reflective mode of operation comprising: a plurality of input fibers for launching a plurality of light beams into the optical switch; a plurality of output ports for selectively receiving the plurality of light beams from any one of the plurality of input ports; an imaging system for one of imaging the light beams from the plurality of input fibers to an imaging plane and from the imaging plane to the plurality of output fibers; and beam directing means for intercepting the light beams that were launched into the optical switch before said light beams are imaged to the imaging plane and for selectively directing the light beams from any one of the plurality of input fibers to any one of the plurality of output fibers.

In accordance with an embodiment of the present invention, the at least one input port and the plurality of output ports are disposed in an object plane of the imaging system.

### BRIEF DESCRIPTIONS OF THE DRAWINGS

Exemplary embodiments of the invention will now be described in conjunction with the drawings in which:

FIG. 1 shows a prior art optical switch wherein the beam of each input waveguide is individually collimated;

FIG. 2 presents a schematic view of the optical system of a switch in a reflective configuration with one imaging lens;

FIG. 3 shows a schematic view of the imaging function of the imaging lens;

FIG. 4 presents a schematic view of the reflective optical system of the switch using a telecentric imaging system;

FIG. 5 shows a close up view of section A of FIG. 4;

FIG. 6 shows a schematic view of the two-dimensional array of the fiber bundle having a honeycomb structure;

FIG. 7 shows a schematic view of the two-dimensional array of the MEMS mirrors having a honeycomb structure;

FIG. 8 shows a schematic view of an optical switch in accordance with the invention in a transmissive configuration;

FIG. 9 shows a schematic view of an optical switch in accordance with the invention using a mirror system as an imaging system; and

FIG. 10 shows a schematic view of another optical switch in accordance with the invention including another mirror system as an imaging system.

### DETAILED DESCRIPTION OF THE INVENTION

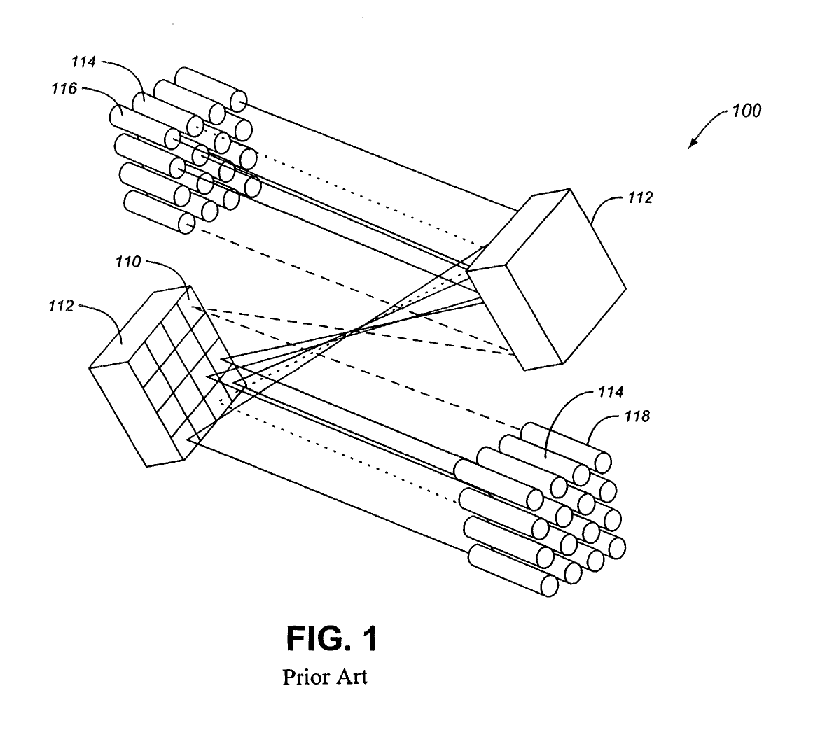

Turning now to FIG. 1 a prior art optical switch or cross-connect structure 100 is shown, wherein micro-mirrors 110 on a MEMS chip 112 are used to fold the design. The folded optical pathway configuration allows for a compact switch design using the movable mirror based beam directing unit. However, the general approach in this type of prior art optical cross connectors is to individually collimate each input waveguide and direct the beam to its dedicated mirror. This mirror then deflects this beam to any one of the plurality of output mirrors which then redirects the beam, i.e. compensates for the angle, to its dedicated output waveguide. As is seen from FIG. 1, this design requires the use of a lens 114 for each individual input fiber of input fiber bundle 116 and each individual output fiber of output fiber bundle 118.

The present invention provides an optical switch or a large scale fiber-optical cross-connect switch wherein the light from the grouped input fibers is collected by a lens, a lens system, a mirror, or a mirror system, and imaged with a certain magnification to an imaging plane. The imaging plane is either a mirror when the system is operated in reflection, or a plane of symmetry when the system is operated in transmission. Before reaching that plane, the spatially separated beams are intercepted by a (1 or) 2-D micro mirror input MEMS array, where each mirror can deviate its dedicated input beam to any mirror on the output MEMS array. Each mirror on the output MEMS array compensates for angular tilt and deviates the beam to its dedicated output port.

This design of the optical switch in accordance with the present invention is based on a single lens, a lens system, a mirror, or a mirror system for imaging the input light beams to a MEMS 2D mirror array. The optical switch is built in a reflective configuration or, if desired, in a transmissive configuration.

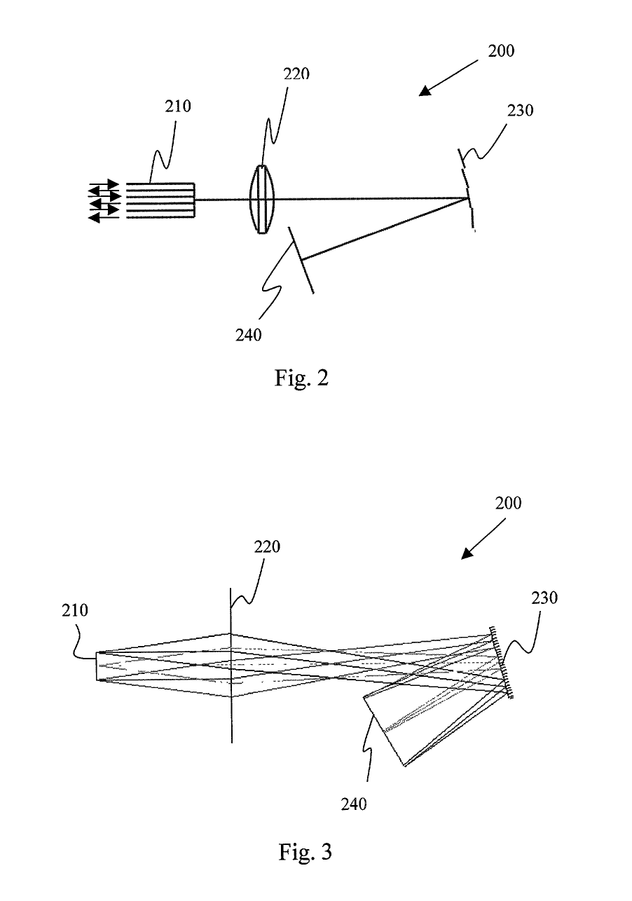

FIG. 2 presents a schematic view of the optical system of a switch 200 in a reflective configuration including an input and output fiber bundle 210, an imaging lens 220, a MEMS chip 230 with 2D tiltable micro-mirrors and a bulk mirror 240 disposed in the imaging plane of the imaging lens 220. Input fibers of fiber bundle 210 are denoted with an arrowhead pointing to the right and output fibers of fiber bundle 210 are denoted with an arrowhead pointing to the left of the figure.

FIG. 3 shows a schematic view of the imaging function of the imaging lens 220 from the input/output fiber bundle 210 to the bulk mirror 240 and not the retro-reflected beams from the bulk mirror 240 back to the input/output fiber bundle 210. The geometrical image of the output surface of the input/output fiber bundle 210 is slightly behind the mirror 240. As shown, as the input beams are imaged to the bulk mirror 240, they are intercepted by the MEMS array 230 once the beams are spatially resolvable. The MEMS array 230 includes input and output micro mirrors in this reflective configuration. Each one of the input mirrors on the MEMS array can deviate its dedicated input beam angularly and therefore laterally on the bulk mirror 240, so that by the time it returns to the MEMS array 230, it has been physically displaced on the MEMS chip 230 so that it hits another micro mirror, i.e. one of the output micro mirrors. This output micro mirror redirects the beam back through the imaging lens 220 to hit its dedicated output port/fiber within the input/output fiber bundle 210.

There is an optimal relationship between the input and output beam size and therefore divergence, and the pitch between the fibers in the array, such that the distance from the MEMS chip 230 to the bulk mirror 240 is maximized and such that the number of connected channels is maximized.

While chief rays of each fiber before the lens are parallel to each other, after passing through the lens they diverge. Therefore, the micro mirrors should compensate for non-telecentricity of beam axes.

However, if desired, magnification is used to improve the resolvability of the beams on the MEMS chip.

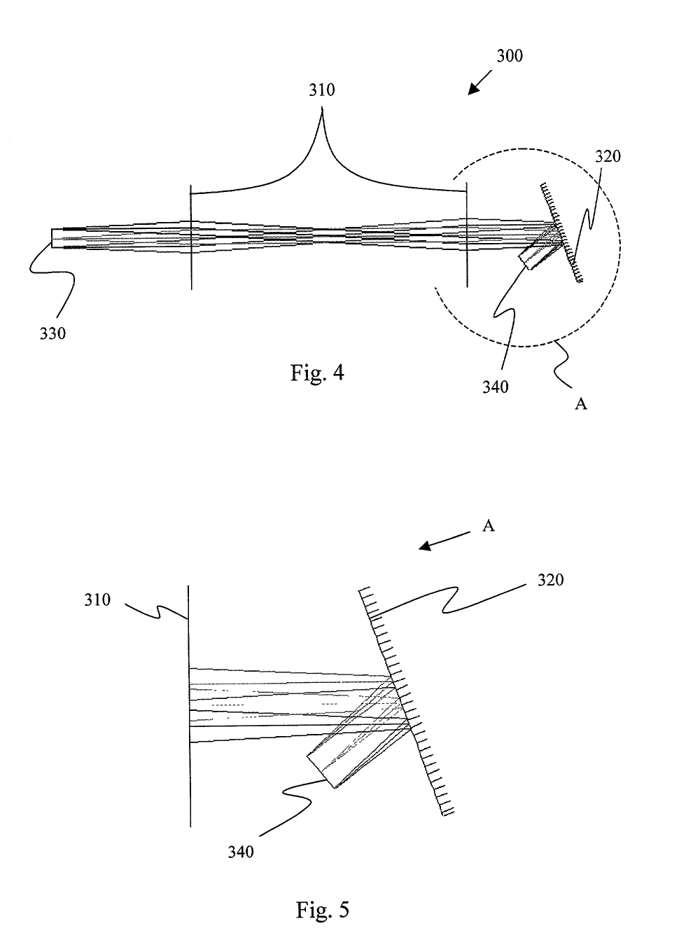

FIG. 4 presents a schematic view of another embodiment of an optical switch 300 in accordance with the invention showing a reflective configuration using a telecentric imaging system 310. Optical switch 300 further includes an input/output fiber bundle 330 and a bulk mirror 340. As is seen, the telecentric imaging system 310 keeps the chief rays of all the input and output beams parallel to the optical axis when they hit the MEMS chip 320. Again, if desired, lateral magnification is used to improve the spatial resolvability of the beams at the MEMS chip320.

FIG. 5 shows a close up view of section A of FIG. 4 of optical switch 300. This close up view demonstrates more clearly the parallelism of the chief rays of the input beams of optical switch 300 at the MEMS chip 320 to the bulk mirror 340.

It is apparent, that in the reflective configuration the fiber bundle 330 consist of both input and output fibers, and the MEMS chip 320 consists of an array of mirrors, each corresponding to a dedicated input or output fiber. However, it is not necessary that there be an equal number of inputs and outputs allowing for the configuration of an N×M optical cross-connect.

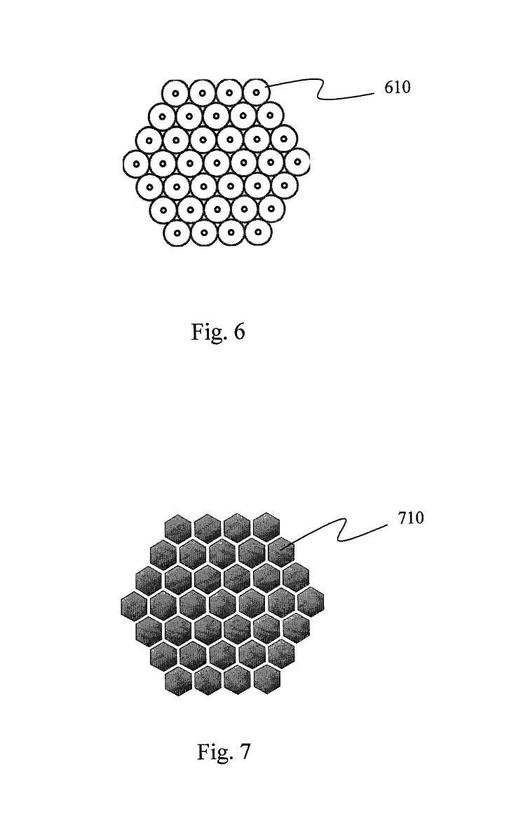

In accordance with another embodiment of the present invention, the structure of the fiber bundle and the MEMS chip is the same. This is advantageous for improving or maximizing the fill-factor. Both, the fiber bundle 610 and the MEMS array 710 can be arranged in a one-dimensional array having a linear arrangement or in a two-dimensional array having a honeycomb structure, for example. Such a honeycomb structure of a fiber bundle 610 and a MEMS array 710 is illustrated in conjunction with FIGS. 6 and 7.

In an exemplary embodiment of the invention, optical switch 200 of FIG. 3 has 37 fibers. These fibers can be a part of 19×19 switch with one spare fiber, for example.

If the input and output fibers are distributed uniformly or randomly over the end face of the fiber bundle, the size of the bulk mirror 240 should be equal to the size of the MEMS chip 230. If however, an upper section of the fiber bundle in FIG. 6 is assigned for input fibers, and a lower part of the fiber bundle for output fibers, then the size of the bulk mirror 240 in a vertical direction can be one half of the size of the MEMS chip. The steering range of micro mirrors in this direction can be cut in half as well.

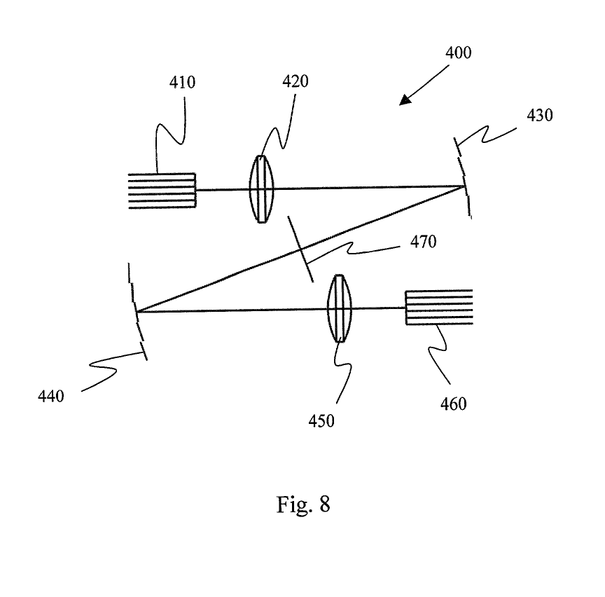

FIG. 8 shows a schematic view of an optical switch 400 in a transmissive configuration including an input fiber bundle 410, a first imaging lens 420, a first MEMS array 430, a second MEMS array 440, a second imaging lens 450, and an output fiber bundle. However, if desired, any kind of waveguide is employed in accordance with the present invention. The bulk mirror surface 240 or 340 of FIGS. 2 to 5 of the reflective configuration, becomes a plane of opto-mechanical symmetry 470 for optical switch 400, wherein a second MEMS chip 440, and second set of imaging optics 450 is used to send the beams to a second fiber bundle, namely output fiber bundle 460.

Thus, optical switch 400 includes two fiber arrays, an input fiber bundle 410 and an output fiber bundle 460. There are two lenses or lens systems, a first lens 420 for imaging the input fibers to an imaging plane 470 and a second lens for imaging the beams to the output fiber bundle 460, and two MEMS chips, a first MEMS chip 430 and a second MEMS chip 440. Each lens or lens system 420 and 450 creates an image of the respective fiber array 410 and 460 in plane 470. This plane 470 is the plane of symmetry of optical switch 400. Advantageously, in accordance with another embodiment of the invention, lens system 420 and 450 is a telecentric system for maintaining the chief rays of the input and output beams parallel to the optical axis when they reach the MEMS chips 430 and 440.

Optical switch 400 does not include a bulk mirror. This system includes more optical parts than the reflective embodiment, but can connect twice as many optical channels.

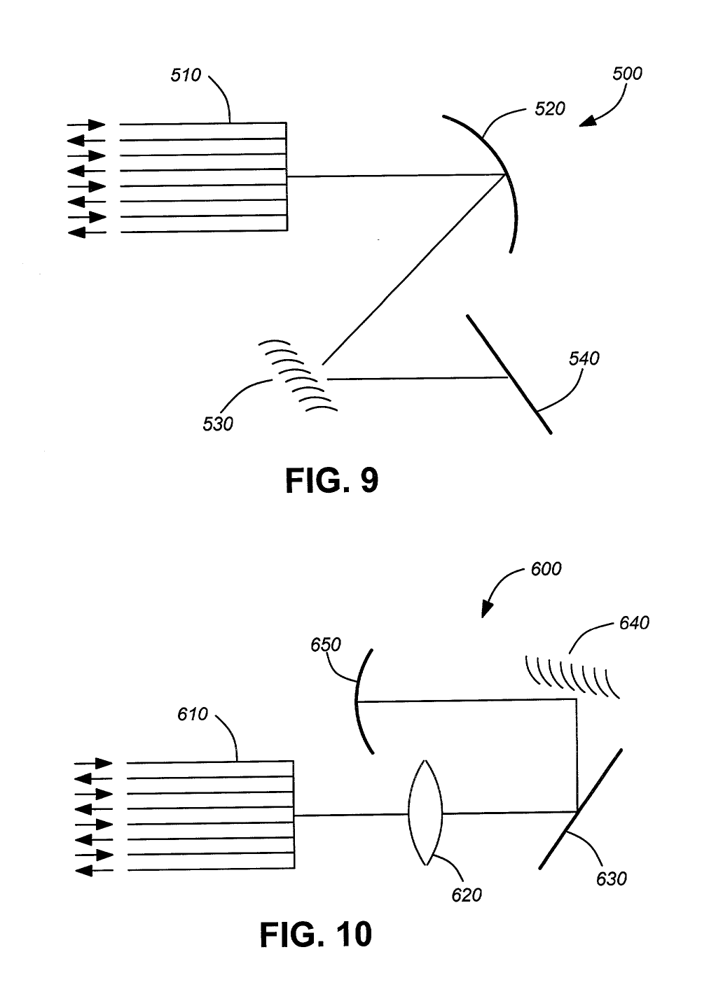

FIG. 9 shows a schematic view of a reflective optical switch 500 in accordance with a further embodiment of the invention using a mirror as the imaging system. Optical switch 500 includes an input/output fiber bundle 510, a curved mirror 520, a MEMS array 530 of 2D tiltable micro mirrors and a bulk mirror 540. The curved mirror 520 is used as the imaging system in place of the lens or lens system discussed above.

FIG. 10 shows a schematic view of another reflective optical switch 600 in accordance with the invention including a mirror system as an imaging system. Optical switch 600 includes an input/output fiber bundle 610, a lens 620, a mirror 630, a MEMS array 640of 2D tiltable micro mirrors, and a bulk mirror 650. Optical switch 600 functions analogously to the reflective switches discussed above with the exception that lens 620 and mirror 630 jointly function as the imaging system in this embodiment.

It is appreciated that an individual fiber may function as an input fiber as well as an output fiber depending upon the direction of propagation of an optical signal in a bi-directional communication environment. Accordingly, although this description includes references to input and output fibers for purposes of illustration, it will be understood that each of the fibers may send and receive optical signals.

Numerous other embodiments can be envisaged without departing from the spirit and scope of the invention.

What is claimed is:

1. An optical switch comprising:
at least one input port for launching a beam of light into the optical switch;
a plurality of output ports, each output port for selectively receiving the beam of light;
beam directing means for selectively directing the beam of light from the input port to any one of the plurality of output ports; and
an element having optical power for imaging the beam of light onto the imaging plane.

2. The optical switch as defined in claim 1 wherein the beam directing means include an array of tiltable micro mirrors.

3. The optical switch as defined in claim 2 wherein the array of tiltable micro mirrors is a MEMS array.

4. The optical switch as defined in claim 1 wherein the element having optical power is one of a lens, a lens system, a mirror, and a mirror system

5. An optical switch comprising:
at least one input port for launching a light beam into the optical switch;
a plurality of output ports for selectively receiving the light beam;
an optical imaging system for imaging the light beam from the at least one input port to an imaging plane and from the imaging plane to the plurality of output ports; and
beam directing means for selectively directing the light beam from the at least one input port to any one of the plurality of output ports, the beam directing means being disposed between the optical imaging system and the imaging plane.

6. The optical switch as defined in claim 5 wherein the at least one input port and the plurality of output ports are disposed in an object plane of the optical imaging system.

7. The optical switch as defined in claim 6 wherein the imaging plane is one of a mirror plane in a reflective mode of operation and a plane of symmetry in a transmissive mode of operation.

8. The optical switch as defined in claim 7 wherein the optical imaging system is one of a lens, a lens system, a mirror, and a mirror system.

9. The optical switch as defined in claim 8 wherein the mirror and the mirror system includes one of a curved mirror and a planar mirror.

10. The optical switch as defined in claim 8 wherein the lens system is a telecentric lens system.

11. The optical switch as defined in claim 5 wherein the beam directing means are disposed to intercept the light beam that was launched into the optical switch before said light beam is imaged to the imaging plane.

12. The optical switch as defined in claim 5 wherein the beam directing means is an array of tiltable micro mirrors.

13. The optical switch as defined in claim 12 wherein the array of tiltable micro mirrors is a MEMS array.

14. The optical switch as defined in claim 5 wherein the at least one input port and the plurality of output ports are arranged in a one-dimensional array or in a two-dimensional array.

15. The optical switch as defined in claim 14 wherein the two-dimensional array has a honeycomb structure for improving a fill factor.

16. The optical switch as defined in claim 5 wherein the at least one input port and the plurality of output ports are arranged in an object plane of the imaging system.

17. An optical switch comprising:
at least one input port for launching a beam of light into the optical switch;
a plurality of output ports for selectively receiving the beam of light;
first imaging means disposed to receive the beam of light from the at least one input port, said first imaging means for imaging the beam of light to a plane of symmetry;
first beam directing means disposed between the first imaging means and the plane of symmetry for directing the beam of light;
second beam directing means disposed after the plane of symmetry in a propagation direction of the beam of light, said second beam directing means for receiving the beam of light from the first beam directing means and for selectively redirecting the beam of light to any one of the plurality of output ports; and
second imaging means disposed between the second beam directing means and the plurality of output ports, said second imaging means for focusing the redirected beam of light to a selected one of the plurality of output ports.

18. The optical switch as defined in claim 17 wherein the at least one input port is disposed in an object plane of the first imaging means and the plurality of output ports are disposed in an object plane of the second imaging means.

19. The optical switch as defined in claim 18 wherein the first and the second beam directing means include an array of micro-mirrors.

20. The optical switch as defined in claim 18 wherein the first and the second imaging means is one of a lens, a lens system, a mirror, and a mirror system.

21. A method for selectively switching an optical signal from an input port to one of a plurality of output ports comprising the steps of:
launching a beam of light into the input port of an optical switch;
imaging the beam of light to an imaging plane;
intercepting the beam of light with beam directing means before said beam of light is imaged onto the imaging plane; and
selectively redirecting the beam of light to one of the plurality of output ports.
